(19) United States
(12) Patent Application Publication
(10) Pub. No.: US 2026/0080572 A1
(43) Pub. Date: Mar. 19, 2026

(54) METHOD FOR HANDLING VIDEO COMPRESSION IN EXTENDED REALITY (XR) ENVIRONMENT BY ELECTRONIC DEVICE

(71) Applicant: SAMSUNG ELECTRONICS CO., LTD., Suwon-si (KR)

(72) Inventor: Chirag GARG, Noida (IN)

(73) Assignee: SAMSUNG ELECTRONICS CO., LTD., Suwon-si (KR)

(21) Appl. No.: 19/353,995

(22) Filed: Oct. 9, 2025

Related U.S. Application Data
(63) Continuation of application No. PCT/KR2025/014198, filed on Sep. 11, 2025.

(30) Foreign Application Priority Data
Sep. 17, 2024 (IN) 202441070162

(51) Int. Cl. G06T 9/00; G06V 10/77

(52) U.S. Cl. CPC G06T 9/001; G06V 10/7715

(57) ABSTRACT

A method for video compression in an extended reality (XR) environment by an electronic device, may include: separating at least one first feature from a multimedia stream; separating at least one second feature from the multimedia stream; applying a first compression to the at least one first feature to generate at least one compressed first feature; applying a second compression to the at least one second feature to generate at least one compressed second feature; generating a loss mapping matrix for the first compression, and the second compression; generating a compressed multimedia stream including the at least one compressed first feature, the at least one compressed second feature, and the loss mapping matrix; and transmitting the compressed multimedia stream to another electronic device.

### CROSS-REFERENCE TO RELATED APPLICATION(S)

This application is a bypass continuation of International Application No. PCT/KR2025/014196, filed on Sep. 11, 2025, which is based on and claims priority to Indian Patent Application number 202441070162, filed Sep. 17, 2024, in the Indian Intellectual Property Office, the disclosures of which are incorporated by reference herein in their entireties.

### BACKGROUND

### 1. Field

The disclosure relates to a video compression method and system, and more particularly, to a method for handling video compression in an extended reality (XR) environment by an electronic device.

### 2. Description of Related Art

FIG. 1 is a flow chart (S100) illustrating a method for handling video compression, according to the related art. At S102, the method includes receiving a multimedia stream. At S104, the method includes applying a compression technique on the multimedia stream. At S106, the method includes transmitting the compressed multimedia stream.

Consider a 360-degree camera as a physical device that captures surrounding details and sends them to a higher official at a remote location with a low-bandwidth network. In the existing method, the process involves receiving the surrounding details video, compressing the surrounding details video, and then transmitting the compressed video. Given this method, transmitting and receiving the surrounding details video takes time. This will affect a user experience.

Similarly, during an online game, a video camera sends a game video to a server. In an existing method, the method includes receiving the game video and applying the compression on the game video. Further, the method includes transmitting the game video. Based on the existing method, transmitting and receiving the game video take time. This will affect a user experience.

Also, in related art solutions, when a full sphere of visual/audio information is transmitted, the full sphere of visual/audio information requires high bandwidth/high bitrate for streaming, hence slows down the process and deteriorates the user experience.

### SUMMARY

According to an aspect of the disclosure, a method for video compression in an extended reality (XR) environment by an electronic device, may include: separating at least one first feature from a multimedia stream; separating at least one second feature from the multimedia stream; applying a first compression to the at least one first feature to generate at least one compressed first feature; applying a second compression to the at least one second feature to generate at least one compressed second feature; generating a loss mapping matrix for the first compression, and the second compression; generating a compressed multimedia stream including the at least one compressed first feature, the at least one compressed second feature, and the loss mapping matrix; and transmitting the compressed multimedia stream to another electronic device.

The method may further include: storing the compressed multimedia stream in memory of the electronic device.

The method may further include: reconstructing the compressed multimedia stream.

The reconstructing the compressed multimedia stream includes: reconstructing the at least one first feature from a compressed format using a generative data driven model to generate at least one reconstructed first feature; reconstruct the at least one second feature from the compressed format using the generative data driven model to generate at least one reconstructed second feature; and reconstructing the compressed multimedia stream by using the at least one reconstructed first feature and the at least one reconstructed second feature.

The at least one first feature may include at least one of: pixel information, depth information, spatial coefficient information, or edge information, and wherein the at least one second feature may include at least one of: an amplitude, a frequency, or spatial audio information.

The at least one first feature may be a video feature, and the at least one second feature may be an audio feature.

Based on the at least one first feature corresponding to a video feature, the separating the at least one first feature from the multimedia stream may include: estimating a number of frames that an aggregator can accommodate based on at least one of: a width of the frames, or a length of the frames; determining whether the frames are aggregated in a horizontal stacking or a vertical stacking based on an aspect ratio of the frames; and separating the at least one first feature from the multimedia stream based on estimating the number of the frames and determining whether the frames are aggregated in the horizontal stacking or the vertical stacking based on the aspect ratio of the frames.

The at least one second feature may be separated from the multimedia stream prior to noise removal process associated with the at least one second feature.

The multimedia stream may be obtained by determining a time frame of the multimedia stream to be computed for frame aggregation and compression based on at least one of: computational power, speed, aspect ratio, or network performance.

The loss mapping matrix may be generated based on a pixel value between a lower pixel threshold and an upper pixel threshold, wherein the lower pixel threshold and the upper pixel threshold are varied based on an average intensity of pixels, wherein the lower pixel threshold and the upper pixel threshold are used to achieve near to lossless reconstruction of the compressed multimedia stream.

The loss mapping matrix may be generated by: determining a difference between an original down-sampled aggregated frame and a reconstructed aggregated frame; and determining a normal distribution of pixel loss and defining a range from which the electronic device is to generate the loss mapping matrix.

The range may include at least one of: 0-63, 64-127, 128-191, or 192-255.

Factoring in the normal distribution of the pixel loss, the loss mapping matrix may be generated as: a row number in the loss mapping matrix; a column number in the loss mapping matrix; red, green and blue values; and a difference pixel value.

The loss mapping matrix may be provided with a feature metadata.

According to an aspect of the disclosure, an electronic device may include: a communication interface; at least one processor; and memory storing one or more instructions. The one or more instructions, when executed by the at least one processor individually or collectively, may cause the electronic device to: separate at least one first feature from a multimedia stream; separate at least one second feature from the multimedia stream; apply a first compression to the at least one first feature to generate at least one compressed first feature; apply a second compression to the at least one second feature to generate at least one compressed second feature; generate a loss mapping matrix for the first compression and the second compression; generate a compressed multimedia stream including the at least one compressed first feature, the at least one compressed second feature and the loss mapping matrix; and transmit, by the communication interface, the compressed multimedia stream to another electronic device.

The one or more instructions, when executed by the at least one processor individually or collectively, may further cause the electronic device to store the compressed multimedia stream in the memory.

The one or more instructions, when executed by the at least one processor individually or collectively, may further cause the electronic device to reconstruct the compressed multimedia stream.

The one or more instructions, when executed by the at least one processor individually or collectively, may further cause the electronic device to: reconstruct the at least one first feature from a compressed format using a generative data driven model to generate at least one reconstructed first feature; reconstruct the at least one second feature from the compressed format using the generative data driven model to generate at least one reconstructed second feature; and reconstruct the compressed multimedia stream by using the at least one reconstructed first feature and the at least one reconstructed second feature.

The at least one first feature may include at least one of: pixel information, depth information, spatial coefficient information, or edge information, and wherein the at least one second feature may include at least one of: an amplitude, a frequency, or spatial audio information.

The at least one first feature may be a video feature, and the at least one second feature is an audio feature.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF THE DRAWINGS

The above and other aspects, features, and advantages of specific embodiments of the present disclosure will be more apparent from the following description with reference to the accompanying drawings, in which:

FIG. 1 is a flow chart illustrating a method for handling video compression, according to the related art;

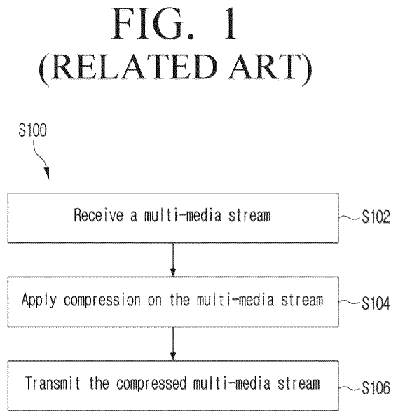

FIG. 2 shows various hardware components of an electronic device, according to one or more embodiments of the disclosure;

FIG. 3 shows various hardware components of an XR content controller included in the electronic device, according to one or more embodiments of the disclosure;

FIG. 4 shows various hardware components of a segment and fragment analysis unit (SFAU) included in the XR content controller, according to one or more embodiments of the disclosure;

FIG. 5 shows an example illustration in which operations of the segment and fragment analysis unit is explained, according to one or more embodiments of the disclosure;

FIG. 6 shows various hardware components of a frame and audio aggregation and compression unit included in the XR content controller, according to one or more embodiments of the disclosure;

FIG. 7 shows various hardware components of a frame analyzer and aggregator (FAA) included in the frame and audio aggregation and compression unit, according to one or more embodiments of the disclosure;

FIG. 8 shows an example illustration in which operations of the frame analyzer and aggregator is explained, according to one or more embodiments of the disclosure;

FIG. 9 shows various hardware components of an audio separation unit (ASU) included in the frame and audio aggregation and compression unit, according to one or more embodiments of the disclosure;

FIG. 10 shows an example illustration in which operations of a loss computation engine included in the XR content controller is explained, according to one or more embodiments of the disclosure;

FIG. 11 shows various hardware components of a reconstruction and blending unit included in the XR content controller, according to one or more embodiments of the disclosure;

FIG. 12 shows an example illustration in which operations of a frame reconstruction unit (FRU) included in the reconstruction and blending unit is explained, according to one or more embodiments of the disclosure;

FIG. 13 shows an example illustration in which operations of an audio reconstruction unit (ARU) included in the reconstruction and blending unit is explained, according to one or more embodiments of the disclosure;

FIG. 14 shows an example illustration in which operations of a Loss Blending Engine (LBE) included in the reconstruction and blending unit is explained, according to one or more embodiments of the disclosure;

FIG. 15 shows various hardware components of a multimedia stream reconstruction unit included in the XR content controller, according to one or more embodiments of the disclosure;

FIG. 16 shows an example illustration in which operations of a multimedia stream reconstruction unit included is explained, according to one or more embodiments of the disclosure; and

FIG. 17 is a flow chart illustrating a method for handling video compression, according to one or more embodiments of the disclosure.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

As used herein, expressions such as “at least one of,” when preceding a list of elements, modify the entire list of elements and do not modify the individual elements of the list. For example, the expression, “at least one of A, B, or C,” should be understood as including only A, only B, only C, both A and B, both A and C, both B and C, or all of A, B, and C.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments of the disclosure. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this and should not be construed as sequential ordering/placement/occurrence unless specified otherwise.

The embodiments herein achieve a method for handling video compression in an XR environment by an electronic device. The method includes separating at least one first feature from a multimedia stream. Further, the method includes separating at least one second feature from the multimedia stream. Further, the method includes applying a first compression to the at least one first feature. Further, the method includes applying a second compression to the at least one second feature. Further, the method includes computing a loss mapping matrix for the first compression, and the second compression. Further, the method includes generating a compressed multimedia stream comprising the at least one first compressed feature, the at least one compressed second feature, and the computed loss mapping matrix.

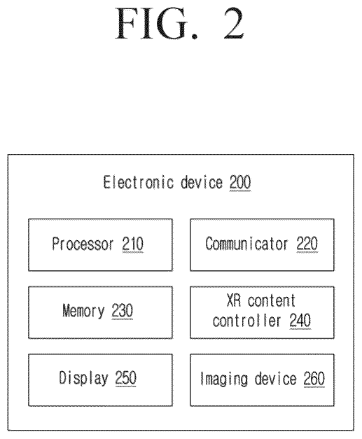

Referring now to the drawings, and more particularly to FIGS. 2 through 17, where similar reference characters denote corresponding features consistently throughout the figures, there are shown embodiments.

FIG. 2 shows various hardware components of an electronic device 200, according to embodiments of the disclosure. The electronic device 200 can be, for example, but not limited to a XR device, a virtual reality (VR) device, an augmented reality (AR) device, a mixed reality (MR) device, a Head-mounted display (HMD) device, AR glasses, and a visual see-through (VST) device. The electronic device 200 can also be for example, but not limited to a laptop, a desktop computer, a notebook, a Device-to-Device (D2D) device, a vehicle to everything (V2X) device, a smartphone, a foldable phone, a smart TV, a tablet, an immersive device, and an internet of things (IoT) device.

In one or more embodiments, the electronic device 200 includes a processor 210, a communicator 220 (communication interface), a memory 230, an XR content controller 240, a display 250, and an imaging device 260 (e.g., camera, video camera or the like). The processor 210 is coupled with the communicator 220, the memory 230, the XR content controller 240, the display 250, and the imaging device 260.

The XR content controller 240 separates a first feature from a multimedia stream (e.g., metaverse video, 360° video, AR video, a VR video, MR video or the like). The multimedia stream may include a full sphere of visual information, audio information and interactive information. The first feature is a video feature. The first feature includes at least one of: pixel information, depth information, spatial coefficient information, or edge information.

In one or more embodiments, when the at least one first feature corresponds the video feature, the XR content controller 240 estimates a number of frames that an aggregator can accommodate based on at least one of: a width of the frames, or a length of the frames. Further, the XR content controller 240 determines whether the frame is aggregated in a horizontal stacking or a vertical stacking based on an aspect ratio of the frame. Further, the XR content controller 240 separates the first feature from the multimedia stream in response to estimating the number of frames and determining whether the frame is aggregated in the horizontal stacking or the vertical stacking based on the aspect ratio of the frame.

The multimedia stream is obtained by determining a time frame of the multimedia stream to be computed for frame aggregation and compression based on computational power, speed, aspect ratio and network performance. In one or more embodiments, the multimedia stream includes interactive information.

Further, the XR content controller 240 separates a second feature from the multimedia stream. The second feature is an audio feature. The second feature includes an amplitude, a frequency and spatial audio information. The second feature is separated from the multimedia stream prior to noise removal process associated with the at least one second feature.

Further, the XR content controller 240 applies a first compression to the first feature. Further, the XR content controller 240 applies a second compression to the at least one second feature.

Further, the XR content controller 240 computes a loss mapping matrix for the first compression and the second compression. The loss mapping matrix is generated based on the pixel value between a lower pixel threshold and an upper pixel threshold. The lower pixel threshold and the upper pixel threshold are varied based on an average intensity of pixels. The lower pixel threshold and the upper pixel threshold are used to achieve near to lossless reconstruction of the compressed multimedia stream.

In one or more embodiments, the loss mapping matrix is generated by computing a difference between an original down-sampled aggregated frame and a reconstructed aggregated frame, and determining a normal distribution of loss pixels and defining a range from which the electronic device 200 computes the loss mapping matrix (loss computation matrix). The range lies in at least one of: 0-63, 64-127, 128-191, or 192-255. Factoring in the normal distribution of the loss pixels, the loss mapping matrix is generated as a row value, a column value, a channel value, and a pixel value, wherein the row value refers to a row number in the loss mapping matrix, wherein the column value refers to a column number in the loss mapping matrix. The channel value refers to red, green and blue values and the pixel value refers to a difference pixel value.

In one or more embodiments, the computed loss mapping matrix is provided with a feature metadata (e.g., segregated frame size, a number of frames, an audio length, and a loss mapping matrix size or the like).

Further, the XR content controller 240 generates a compressed multimedia stream including the first compressed feature, the compressed second feature and the computed loss mapping matrix. Further, the XR content controller 240 stores the compressed multimedia stream at the memory 230 of the electronic device 200. Also, the XR content controller 240 transmits the compressed multimedia stream to another electronic device.

Further, the XR content controller 240 reconstructs the first feature from a compressed format using a generative data driven model. In one or more embodiments, the XR content controller 240 merges a reconstruction loss with reconstructed pixels of the reconstructed first feature. Further, the XR content controller 240 reconstructs the at least one second feature from the compressed format using the generative data driven model. Further, the XR content controller 240 reconstructs the compressed multimedia stream by using the reconstructed first feature and the reconstructed second feature. In one or more embodiments, the compressed multimedia stream is reconstructed by the other electronic device after the other electronic device receives the compressed multimedia stream from the electronic device.

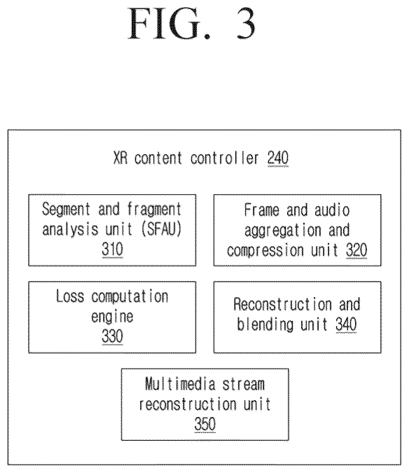

The detailed explanation along with the example for handling the video compression in the XR environment is explained in FIG. 3 to FIG. 16.

The XR content controller 240 is implemented by analog and/or digital circuits such as logic gates, integrated circuits, microprocessors (at least one processor), microcontrollers, memory circuits, memory storing one or more instructions, passive electronic components, active electronic components, optical components, hardwired circuits and the like, and may optionally be driven by firmware.

The (at least one) processor 210 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 3210 may include multiple cores and is configured to execute the instructions stored in the memory 230.

Further, the processor 210 is configured to execute instructions stored in the memory 230 and to cause the electronic device to perform various processes. The communicator 220 is configured for communicating internally between internal hardware components and with external devices via one or more networks. The memory 230 also stores instructions to be executed by the processor 210. The memory 230 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 230 may, in some examples, be considered a non-transitory storage medium. The term “non-transitory” may indicate that the storage medium is not embodied in a carrier wave or a propagated signal. However, the term “non-transitory” should not be interpreted that the memory 230 is non-movable. In certain examples, a non-transitory storage medium may store data that can, over time, change (e.g., in Random Access Memory (RAM) or cache).

Further, at least one of the plurality of modules/controller may be implemented through the AI model/the ML model using a data driven controller (not shown). The data driven controller can be an ML model based controller and an AI model based controller. A function associated with the AI model may be performed through the non-volatile memory, the volatile memory, and the processor 210. The processor 210 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to one or more embodiments is performed, and/or may be implemented through a separate server/system.

The AI model may include of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

In an example, consider a 360-degree camera as a physical device that captures surrounding details and sends them to a higher official at a remote location with a low-bandwidth network. Based on the proposed method, the process involves separating the video feature and the audio feature from the surrounding details video. Further, the method includes applying a first compression and a second compression to the video feature and the audio feature, respectively. Further, the method includes computing the loss mapping matrix for the first compression and the second compression. Further, the method includes generating the compressed multimedia stream comprising the first compressed feature, the compressed second feature, and the computed loss mapping matrix. Further, the method includes transmitting the compressed multimedia stream. Based on the proposed method, the method reduces a transmission and reception delay. Thus results in improving the user experience.

In an example, consider a video camera captures a game video and sends the game video to a server. Based on the proposed method, the process involves separating the video feature and the audio feature from the game video. Further, the method includes applying the first compression and the second compression to the video feature and the audio feature, respectively. Further, the method includes computing the loss mapping matrix for the first compression and the second compression. Further, the method includes generating the compressed multimedia stream comprising the first compressed feature, the compressed second feature, and the computed loss mapping matrix. Further, the method includes transmitting the compressed game video. Based on the proposed method, the method reduces a transmission and reception delay. Thus results in improving the user experience.

Based on the proposed method, when full sphere of visual/audio information is transmitted, the full sphere of visual/audio information requires less bandwidth/less bitrate for streaming, hence improves the processing speed and the user experience. This improved performance is an improvement to the functioning of the computer itself.

The method enables significant reduction in overall size of the multimedia stream and while reproducing use of loss mapping matrix, the method regenerates the video frames with optimum pixel values that are ranging differently for thresholds for varying objects in the frames. This results in improving the user experience.

Although FIG. 2 shows various hardware components of the electronic device 200 but it is to be understood that other embodiments are not limited thereon. In other embodiments, the electronic device 200 may include less or more number of components. Further, the labels or names of the components are used only for illustrative purposes and does not limit the scope of the present disclosure. One or more components can be combined together to perform the same or substantially similar function in the electronic device 200.

FIG. 3 shows various hardware components of the XR content controller 240 included in the electronic device 200, according to embodiments of the disclosure. The XR content controller 240 includes a segment and fragment analysis unit (SFAU) 310, a frame and audio aggregation and compression unit 320, a loss computation engine 330, a reconstruction and blending unit 340 and a multimedia stream reconstruction unit 350. The segment and fragment analysis unit 310, the frame and audio aggregation and compression unit 320, the loss computation engine 330, the reconstruction and blending unit 340 and the multimedia stream reconstruction unit 350 are coupled with each other.

The segment and fragment analysis unit 310, the frame and audio aggregation and compression unit 320, the loss computation engine 330, the reconstruction and blending unit 340 and the multimedia stream reconstruction unit 350 are implemented by analog and/or digital circuits such as logic gates, integrated circuits, microprocessors, microcontrollers, memory circuits, passive electronic components, active electronic components, optical components, hardwired circuits and the like, and may optionally be driven by firmware.

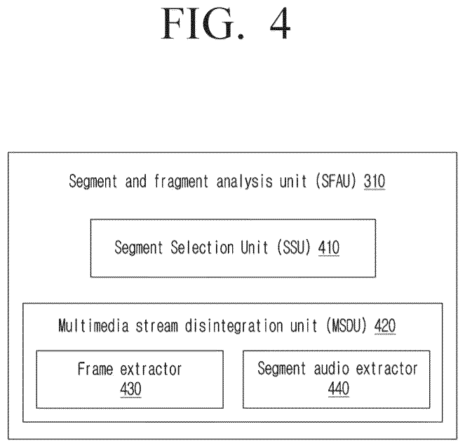

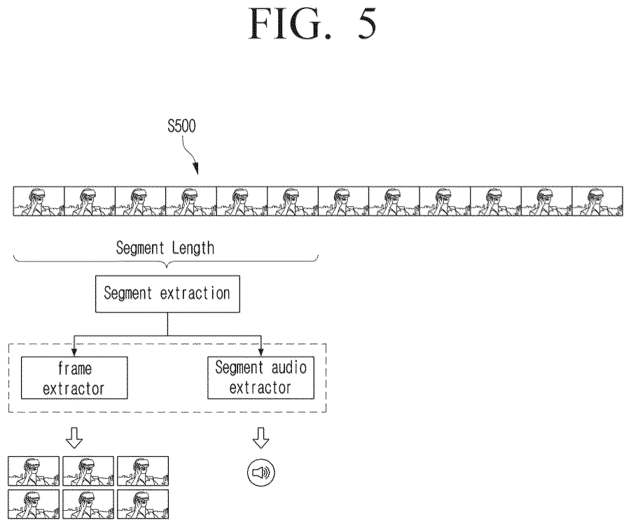

The segment and fragment analysis unit 310 tracks the computational and network performance and on its basis segments the stream and further disintegrates stream to the frames and the audio. The detailed operations and functions of the segment and fragment analysis unit 310 are explained in FIG. 4. The frame and audio aggregation and compression unit 320 determines the aggregation of the audio segments and the video segments to the one frame followed by the compression technique. The detailed operations and functions of the frame and audio aggregation and compression unit 320 is explained in FIG. 5.

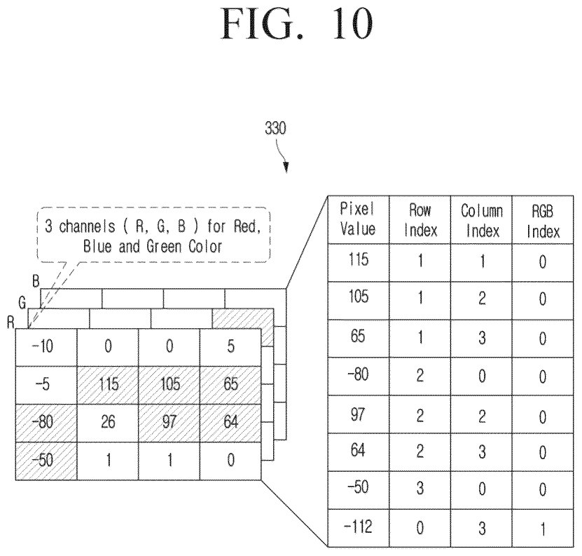

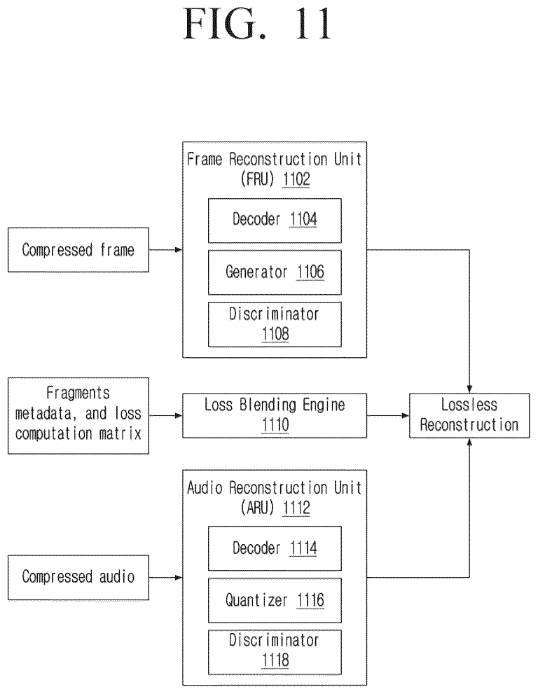

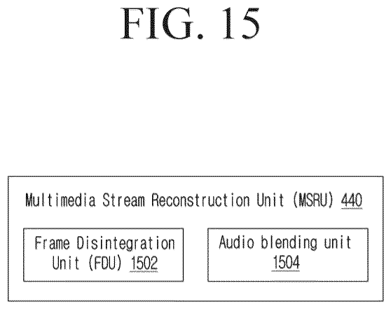

The loss computation engine 330 determines the loss of original and reconstructed segment in order to achieve near to lossless reconstruction. The detailed operations and functions of the loss computation engine 330 is explained in FIG. 10. The reconstruction and blending unit 340 reconstructs the video and audio features along with loss amalgamation. The detailed operations and functions of the reconstruction and blending unit 340 is explained in FIG. 11. The multimedia stream reconstruction unit 350 disintegrates the reconstructed frame and audio into original size frame and regenerates 360 degree content. The detailed operations and functions of the multimedia stream reconstruction unit 350 is explained in FIG. 15.

Although FIG. 3 shows various hardware components of the XR content controller 240 but it is to be understood that other embodiments are not limited thereon. In other embodiments, the XR content controller 240 may include less or more number of components. Further, the labels or names of the components are used only for illustrative purposes and does not limit the scope of the present disclosure. One or more components can be combined together to perform the same or substantially similar function in the XR content controller 240.

FIG. 4 shows various hardware components of the segment and fragment analysis unit 310 included in the XR content controller 240, according to one or more embodiments of the disclosure. In one or more embodiments, the segment and fragment analysis unit includes a segment selection unit (SSU) 410 and a multimedia stream disintegration unit (MSDU) 420.

In one or more embodiments, the segment selection unit 410 selects a segment based on computation efficiency and a network efficiency. In an example, the segment selection unit 410 selects the segment by using below equation (1) as follows:

$$SS = fnss ( Initial SS , ST , AT , TCP , TRP ) \qquad ( 1 )$$

where SS is segment selection frame (SS),
fnss—function to calculate the segment on the basis of sending and acknowledgment time and, time taken by Compression and Reconstruction Process,
ST—time taken by network to send the selected compressed segment.

Initially, it is taken as 125 ms. (approx. 4 frames per segment). The number of frames will be varied based on computational latency and transmission latency, and aspect ratio.
AT—Delay in acknowledgement received from Receiver
TCP—Time taken by Construction Process
TRP—Time taken by Reconstruction Process

If Initial SS> (ST+AT+TCP+TRP), “increase segment duration”

Else, “decrease segment duration”

Further, the multimedia stream disintegration unit 420 disintegrates the number of frames and the audio in the multimedia stream. In an example, the multimedia stream disintegration unit 420 handles decomposing the multimedia stream (which includes both video and audio) into its basic elements such as frames for the video and segments for the audio. The multimedia stream disintegration unit 420 allows for more detailed and manageable analysis, editing, or other processing tasks on the individual components of the multimedia content.

Further, the multimedia stream disintegration unit 420 includes a frame extractor 430 and a segment audio extractor 440. The frame extractor focuses on extracting individual frames from the video stream. In an example, in a video file, the frame extractor 430 would pull out each individual image or frame, allowing for separate analysis or processing of each frame. This can be useful for tasks such as image analysis, video indexing, video compression or the like. The segment audio extractor 440 deals with extracting and processing segments of the audio from the multimedia stream. The segment audio extractor 440 can break down audio tracks into smaller segments based on various criteria like time intervals, silence detection, or predefined markers.

Although FIG. 4 shows various hardware components of the segment and fragment analysis unit 310 but it is to be understood that other embodiments are not limited thereon. In other embodiments, the segment and fragment analysis unit 310 may include less or more number of components. Further, the labels or names of the components are used only for illustrative purposes and does not limit the scope of the present disclosure. One or more components can be combined together to perform the same or substantially similar function in the segment and fragment analysis unit 310.

FIG. 5 shows an example illustration (S500) in which operations of the segment and fragment analysis unit 310 is explained, according to one or more embodiments of the disclosure. In an example, the segment length as decided by segment selection unit 410. By using the frame extractor 430 and the segment audio extractor 440, the multimedia stream disintegration unit 420 extracts the frames (e.g., six frames) and audio (e.g., audio of the six frames).

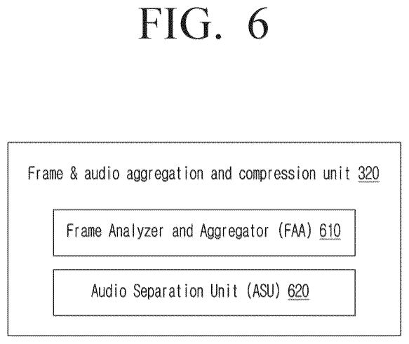

FIG. 6 shows various hardware components of the frame and audio aggregation and compression unit 320 included in the XR content controller 240, according to one or more embodiments of the disclosure.

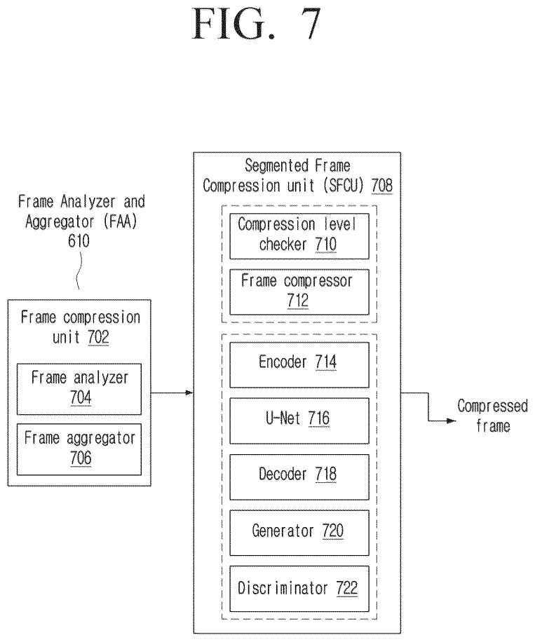

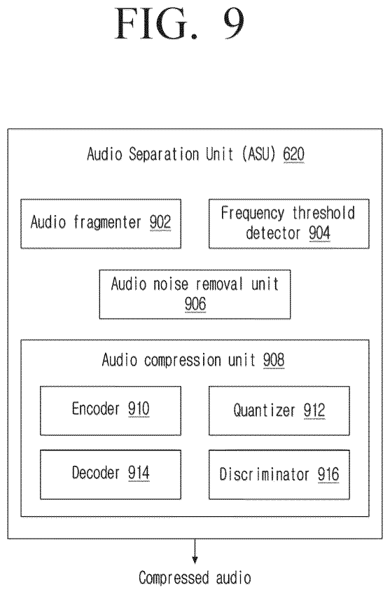

The frame and audio aggregation and compression unit 320 includes a frame analyzer and aggregator (FAA) 610 (explained in FIG. 7 and an audio separation unit (ASU) 620 (explained in FIG. 9. The frame analyzer and aggregator 610 aggregates frames on the basis of frame physical features. The audio separation unit 620 fragments the audio from the selected frame prior to noise removal and compresses the audio.

Although FIG. 6 shows various hardware components of the frame and audio aggregation and compression unit 320 but it is to be understood that other embodiments are not limited thereon. In other embodiments, the frame and audio aggregation and compression unit 320 may include less or more number of components. Further, the labels or names of the components are used only for illustrative purposes and does not limit the scope of the present disclosure. One or more components can be combined together to perform the same or substantially similar function in the frame and audio aggregation and compression unit 320.

FIG. 7 shows various hardware components of the frame analyzer and aggregator 610 included in the frame and audio aggregation and compression unit 320, according to one or more embodiments of the disclosure. The frame analyzer and aggregator 610 includes a frame compression unit 702 and a segmented frame compression unit (SFCU) 708.

The frame compression unit 702 includes a frame analyzer 704 and a frame aggregator 706. The frame analyzer 704 focuses on examining and processing individual frames based on an aspect ratio, the frame features, and priority (e.g., aggregation stack priority). Further, the frame analyzer 704 prepares frames for efficient compression by ensuring consistency and extracting relevant data for optimal encoding.

In an example, the frame analyzer 704 examines the aspect ratio of each frame to ensure consistency and optimize compression. Further, the frame analyzer 704 may involve identifying frames with non-standard aspect ratios or adjusting them to match a target aspect ratio.

In an example, the frame analyzer 704 extracts various features from each frame, such as spatial complexity, motion patterns, and scene changes. This involves analyzing details like texture, edges, and object presence. Understanding the frame features helps in applying appropriate compression techniques. For example, frames with high spatial complexity might be compressed differently compared to simpler frames. Features like motion vectors are used in predictive coding to reduce redundancy and enhance compression.

In an example, the frame analyzer 704 assigns priority levels to frames based on their content and importance. This can involve identifying keyframes (intra-coded frames) and less critical frames (inter-coded frames) within the video sequence. The priority stacking optimizes the compression process by focusing on encoding keyframes with high quality, while using predictive coding techniques for subsequent frames. This reduces the overall bit rate while maintaining visual quality where it is required.

Also, the aspect ratio of a frame helps to determine whether the frames will be aggregated in horizontal stacking or vertical stacking.

$$If ( W > H ) ,$$

if (W>2*H), Only one Horizontal Stacking followed by multiple Vertical Stacking
else, Horizontal Stacking followed by Vertical Stacking

Else,
if (H>2*W), Only one Vertical Stacking followed by multiple Horizontal Stacking
else, Vertical stacking followed by Horizontal Stacking
where W of the frame is width and H is height of the frame

The frame aggregator 706 consolidates and reassembles frames while maintaining aspect ratio consistency, integrating the frame features, and adhering to the priority levels, to produce a coherent and optimized final multimedia output for the frame compression.

In an example, the frame aggregator 706 ensures that all frames in a final compressed output maintain a consistent aspect ratio. This may involve cropping, padding, or resizing frames before final encoding. Maintaining the aspect ratio consistency helps in preventing visual distortions and ensuring that the compressed video can be correctly displayed on various devices.

In an example, the frame aggregator 706 also combines and integrates features extracted from different frames to optimize the compression process. For instance, it might aggregate motion vectors and spatial details to enhance predictive encoding schemes. By consolidating frame features, the frame aggregator 706 improves the efficiency of encoding algorithms. Also, the frame aggregator 706 helps in managing temporal and spatial redundancies more effectively, leading to better compression ratios and overall video quality.

In an example, the frame aggregator 706 uses priority information to determine how to allocate compression resources. Keyframes are encoded with higher quality, while other frames might use lower bit rates or more aggressive compression techniques. This integration ensures that the most important frames (keyframes) retain high quality, while the rest of the video is compressed efficiently.

The aggregate frames are provided to the segmented frame compression unit (SFCU). The segmented frame compression unit 708 includes a compression level checker 710, a frame compressor 712, an encoder 714, a U-Net 716, a decoder 718, a generator 720 and a discriminator 722.

The SFCU compresses the aggregated frame via two ways such as lossless compression using related art methods and a generative AI auto encoder model to further compress the frame. For the lossless compression using related art methods, the compression level checker 710 and the frame compressor 712 are used.

The compression level checker 710 verifies that the aggregated output from multiple frames aligns with the overall compression need. Also, the compression level checker 710 assesses whether the aggregated frame features and priorities are respected in a final compressed video. Also, the compression level checker 710 checks if the aggregation process maintains the expected quality and compression ratio for the video compression. The frame compressor 712 processes aggregated frames, ensuring that the combined data from multiple frames is compressed effectively. This might involve compressing frames based on their aggregated features and priorities. The frame compressor 712 achieves effective compression of grouped or aggregated frames and maintains the overall video quality and reduces a file size according to the aggregated information.

For the generative AI auto encoder model, the encoder 714, the U-Net 716, the decoder 718, the generator 720 and the discriminator 722 are used. The encoder 714 takes the aggregated frame and encodes the aggregated frame into a compressed bitstream. The encoder 714 ensures that an encoding process adheres to the priorities and features identified during the aggregation. The U-Net 716 can be used to process aggregated frames to refine or restore details before encoding. The U-Net 716 assists in reconstructing or enhancing frames based on aggregated data. The decoder 718 processes the aggregated compressed frames and reconstructs them according to the aggregated features and priorities. The decoder 718 ensures that the final output maintains consistency with the aggregated frame data. The generator 720 creates frames based on the aggregated data, ensuring that the output is consistent with the aggregated features and priorities. The discriminator 722 evaluates the quality of generated or reconstructed frames to ensure they meet standards based on the aggregation.

Although FIG. 7 shows various hardware components of the frame analyzer and aggregator 610 but it is to be understood that other embodiments are not limited thereon. In other embodiments, the frame analyzer and aggregator 610 may include less or more number of components. Further, the labels or names of the components are used only for illustrative purposes and does not limit the scope of the present disclosure. One or more components can be combined together to perform the same or substantially similar function in the frame analyzer and aggregator 610.

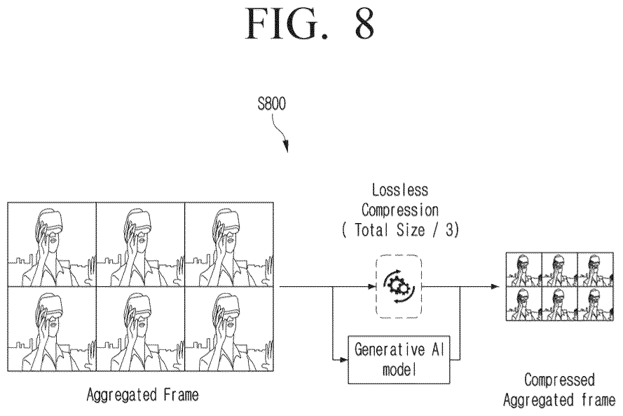

FIG. 8 shows an example illustration (S800) in which operations of the frame analyzer and aggregator (6610 is explained, according to one or more embodiments of the disclosure. The lossless compression uses a related art method to reduce the frame size to (for example size/3, size/4, size/6 or the like), so as to achieve a high level of compression with minimal loss. Also, the generative AI model further compresses to achieve higher level of compression while minimizing the loss.

FIG. 9 shows various hardware components of the audio separation unit 620 included in the frame and audio aggregation and compression unit 320, according to one or more embodiments of the disclosure. The audio separation unit 620 includes an audio fragmenter 902, a frequency threshold detector 904 and an audio noise removal unit 906.

The audio fragmenter 902 segments the audio based on the aggregated video frame data to create meaningful audio fragments that align with the video content. Also, the audio fragmenter 902 creates audio fragments based on the aggregated data from the frames. For example, if the video frames indicate scene changes or specific events, the audio fragmenter 902 can align audio fragments with these events for synchronized processing.

The frequency threshold detector 904 filters and processes audio frequencies using thresholds informed by aggregated frame data, improving the relevance and quality of audio processing. Further, the frequency threshold detector 904 applies frequency thresholds to filter out or emphasize certain frequencies. For instance, if the aggregated frame data indicates high activity or important events, the detector might adjust thresholds to focus on relevant audio frequencies. The thresholds are set by a user of the electronic device 200 or an original equipment manufacturer (OEM).

The audio noise removal unit 906 removes a noise based on a minimum threshold and a maximum threshold. The minimum threshold and the maximum threshold are set by the user of the electronic device 200 or the OEM.

In an audio compression unit 908, the encoder 910 transforms raw audio data into a compressed format by applying various compression techniques. The encoder 910 compresses the audio by extracting features, applying transforms, quantizing data, and encoding it efficiently. The quantizer 912 reduces the precision of audio data by mapping continuous values to discrete levels, balancing compression efficiency with quality loss. The decoder 914 reverses the compression process by reconstructing the original audio signal from the compressed data. The decoder reconstructs the original audio from compressed data by reversing encoding steps, de-quantizing, and applying inverse transforms. The discriminator 916 assesses the quality of reconstructed audio to ensure high fidelity and provides feedback to improve the compression process.

Although FIG. 9 shows various hardware components of the audio separation unit 620 but it is to be understood that other embodiments are not limited thereon. In other embodiments, the audio separation unit 620 may include less or more number of components. Further, the labels or names of the components are used only for illustrative purposes and does not limit the scope of the present disclosure. One or more components can be combined together to perform the same or substantially similar function in the audio separation unit 620.

FIG. 10 shows an example illustration in which operations of a loss computation engine 330 included in the XR content controller 240 is explained, according to one or more embodiments of the disclosure.

By using the loss computation engine 330, the loss mapping matrix is generated based on the pixel value between the lower pixel threshold and the upper pixel threshold. The lower pixel threshold and the upper pixel threshold are varied based on the average intensity of pixels. The lower pixel threshold and the upper pixel threshold are used to achieve near to lossless reconstruction of the compressed multimedia stream. The computed loss mapping matrix is provided with a feature metadata (e.g., segregated frame size, a number of frames, an audio length, and a loss mapping matrix size or the like).)

In one or more embodiments, the loss mapping matrix is generated by computing a difference between the original down-sampled aggregated frame and the reconstructed aggregated frame, and determining the normal distribution of the loss pixels and defining the range from which the electronic device 200 computes the loss mapping matrix. The range comprises at least one of: 0-63, 64-127, 128-191, or 192-255. Factoring in the normal distribution of the loss pixels, the loss mapping matrix is generated in the form of the row value, the column value, the channel value, and the pixel value. The row value refers to a row number in the loss mapping matrix. The column value refers to a column number in the loss mapping matrix. The channel value refers to red, green and blue values and the pixel value refers to a difference pixel value.

In an example, as per the plot in the graph, Min Th=40 Pixel intensity and Max Th=120 Pixel intensity, the user of the electronic device 200 consider for R, G and B as based on the below equation (2) as follows:

$$Min Th <= ABS ( Loss Pixel ) <= Max Th \qquad ( 2 )$$

The loss mapping matrix will be sent with compressed data for achieving near to lossless reconstruction.

FIG. 11 shows various hardware components of the reconstruction and blending unit 340 included in the XR content controller 240, according to one or more embodiments of the disclosure. The reconstruction and blending unit 340 includes a frame reconstruction unit 1102, an audio reconstruction unit 11112 and a loss blending engine 11110.

The frame reconstruction unit 1102 receives the compressed frame features. Further, the frame reconstruction unit 1102 reconstructs the frame from compressed format using the generative AI model. The frame reconstruction unit 1102 includes a decoder 1104, a generator 1106, and a discriminator 1108.

The decoder 1104 reconstructs video frames from compressed features by decoding, de-quantizing, and applying inverse transforms to recreate the original frame. The generator 1106 creates or enhances video frames from compressed features, using advanced models to produce high-quality or improved frames. The discriminator 1108 evaluates the quality of reconstructed or generated frames, ensuring they meet visual standards and providing feedback to improve frame reconstruction. In shorts, the frame reconstruction unit 1102 performs a Segmented Frame Reconstruction (SFR)

The audio reconstruction unit 1112 receives a compressed audio features. Upon receiving the compressed audio features, The audio reconstruction unit 1112 reconstruct the audio segment from compressed format using the AI model. The audio reconstruction unit 1112 includes a decoder 1114, a quantizer 1116, and a discriminator 1118. The decoder 1114 converts compressed audio features back into the original audio signal by decoding, de-quantizing, and applying inverse transforms. The quantizer 1116 maps continuous audio data to discrete levels to compress it, managing the trade-off between compression efficiency and quality. The discriminator 1118 evaluates the quality of reconstructed audio against the original, ensuring high fidelity and providing feedback to improve reconstruction. In shorts, the audio reconstruction unit performs a Segmented audio Reconstruction (SAR)

The loss blending engine 1110 amalgamates the loss with reconstructed pixels to minimize overall loss. The loss blending engine 1110 receives the reconstructed frame information and produces the lossless reconstruction frame.

Although FIG. 11 shows various hardware components of the reconstruction and blending unit 340 but it is to be understood that other embodiments are not limited thereon. In other embodiments, the reconstruction and blending unit 340 may include less or more number of components. Further, the labels or names of the components are used only for illustrative purposes and does not limit the scope of the present disclosure. One or more components can be combined together to perform the same or substantially similar function in the reconstruction and blending unit 340.

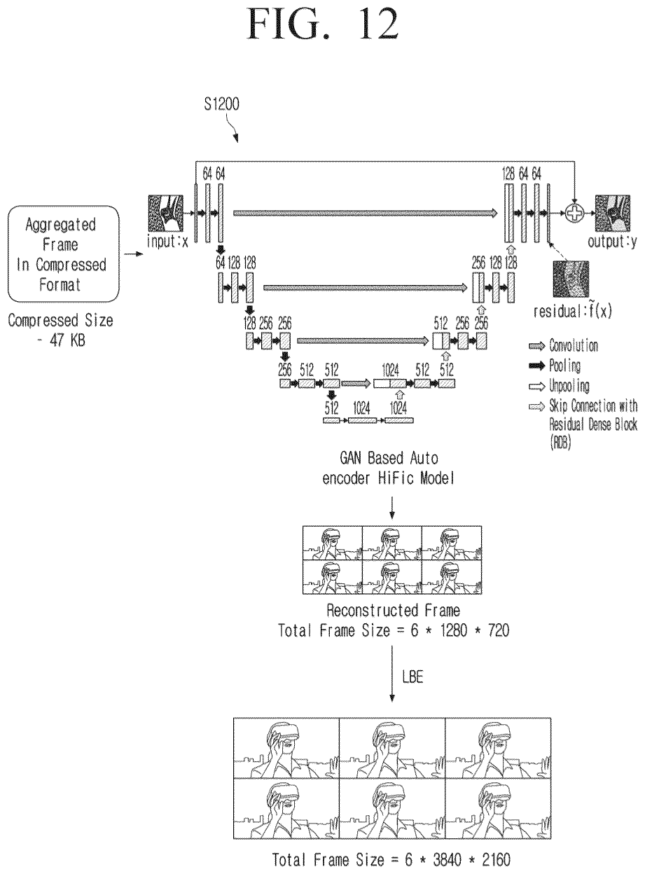

FIG. 12 shows an example illustration (S1200) in which operations of the frame reconstruction unit 1102 included in the reconstruction and blending unit 340 is explained, according to one or more embodiments of the disclosure. The reconstruction and blending unit 340 receives the aggregated frame in a compressed format. By using a GAN based auto encoder (for example), the reconstruction and blending unit 340 reconstructs the frame. Further, the loss blending engine 11110 amalgamates the loss with reconstructed pixels to minimize overall loss.

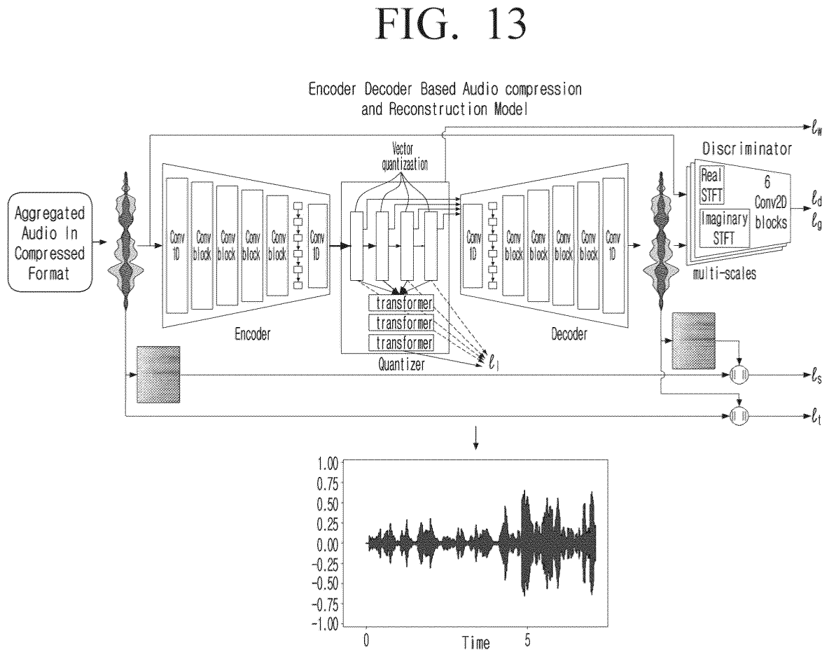

FIG. 13 shows an example illustration (S1300) in which operations of the audio reconstruction unit 1112 included in the reconstruction and blending unit 340 is explained, according to one or more embodiments of the disclosure. The reconstruction and blending unit 340 performs a segmented audio reconstruction. In the segmented audio reconstruction, the reconstruction and blending unit 340 receives the aggregated audio in the compressed format. By using an encoder decoder based audio compression and reconstruction model, the reconstruction and blending unit 340 reconstructs the audio.

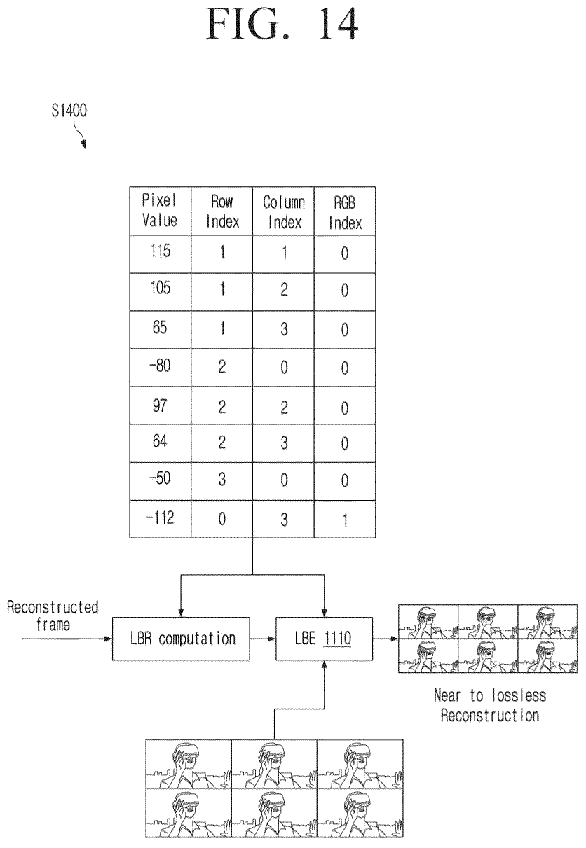

FIG. 14 shows an example illustration (S1400) in which operations of the loss blending engine 11110 included in the reconstruction and blending unit 340 is explained, according to one or more embodiments of the disclosure. In an example, the loss blending engine 11110 performs the loss blending rate computation based on the loss mapping matrix and reconstructed frame (RF) RF with the formula specified in equation (3) as follows:

$$0 <= LBR <= 1 \qquad ( 3 )$$

$$If ( loss pixels + reconstructed frame pixels ) > 255 , LBR < 1$$

$$else , LBR = 1$$

The loss blending engine 11110 blends the loss based on a Loss Blending Rate (LBR), the RF and the Loss mapping matrix to produce the lossless reconstruction frame by using equation (4) as follows:

$$RF = RF + LBR * LCM \qquad ( 4 )$$

FIG. 15 shows various hardware components of the multimedia stream reconstruction unit 350 included in the XR content controller 240, according to one or more embodiments of the disclosure. The multimedia stream reconstruction unit 350 includes a frame disintegration unit 1502 and an audio blending unit 1504. The frame disintegration unit 1502 receives the metadata and the reconstructed frame from the loss blending engine 11110 to produce the disintegrated frames of original size with minimal loss.

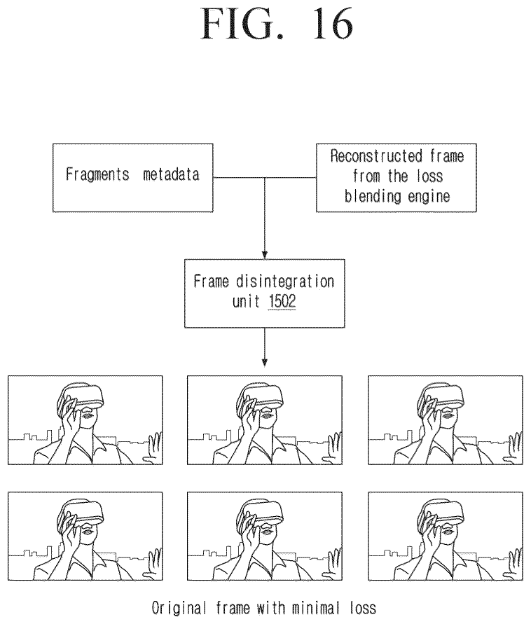

The audio blending unit 1504 receives the metadata and the reconstructed audio to reconstruct the frame with an original size with the audio. FIG. 16 shows an example illustration (S1600) in which operations of the multimedia stream reconstruction unit included is depicted.

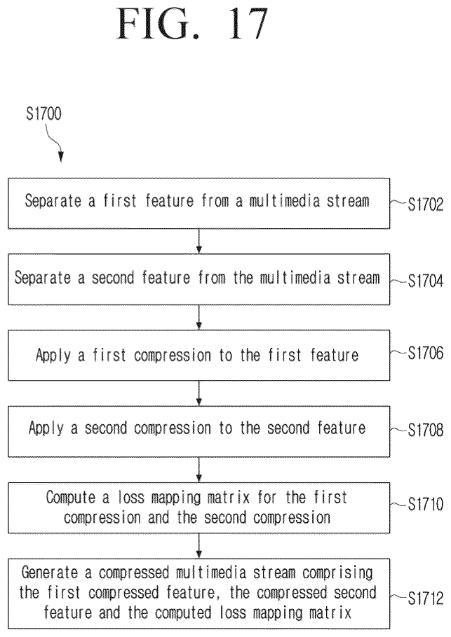

FIG. 17 is a flow chart (S1700) illustrating a method for handling video compression, according to one or more embodiments of the disclosure. The operations (S1702-S1712) are handled by the XR content controller 240.

At S1702, the method includes separating the first feature from the multimedia stream. At S1704, the method includes separating the second feature from the multimedia stream. At S1706, the method includes applying the first compression to the first feature. At S1708, the method includes applying the second compression to the second feature.

At S1710, the method includes computing the loss mapping matrix for the first compression, and the second compression. At S1712, the method includes generating the compressed multimedia stream comprising the first compressed feature, the compressed second feature, and the computed loss mapping matrix.

One more embodiments herein disclose a method for handling video compression in an extended reality (XR) environment by an electronic device.

One or more embodiments herein separate a first feature and a second feature from a multimedia stream.

One or more embodiments herein apply a first compression and a second compression to the first feature and the second feature, respectively.

One or more embodiments herein compute a loss mapping matrix for the first compression and the second compression.

One or more embodiments herein generate a compressed multimedia stream including the first compressed feature, the compressed second feature and the computed loss mapping matrix.

One or more embodiments herein transmit the compressed multimedia stream to another electronic device.

One or more embodiments herein reconstruct the compressed multimedia stream.

Based on the proposed method, when full sphere of visual/audio information is transmitted, the full sphere of visual/audio information requires less bandwidth/less bitrate for streaming, hence improves the processing speed and a user experience.

The proposed method enables significant reduction in the overall size of the multimedia stream. While reproducing use of loss mapping matrix, the proposed method regenerates the video frames with optimum pixel values that are ranging differently for thresholds for varying objects in the frames. This results in improving the user experience. The proposed method maintains smoothness and immersive experience in the multimedia stream (e.g., metaverse video, 360° video, AR video, VR video, MR video or the like)

Based on the proposed method, same bit rate at a receiver end is achievable. As the compression and reconstruction is done via generative AI auto encoders and blending of loss to the reconstructed image. It is able to achieve near to lossless reconstruction. The proposed method reduces buffering size. The proposed method does not need a content distribution server for handling video compression in the XR environment. Real time content transmission is possible. The higher compression rates are achievable with quality intact. The method can be used for handling the video compression in an XR environment with a small computation resource and low latency.

The proposed method can be used for dynamic prediction of segmenting video, audio and the interactive data based on network and computational performance. The method can be used for dynamically aggregating the multiple video and audio frames into one frame to achieve more speed and accuracy. The generative AI based method can be used to compress the frames features and the audio features so as to achieve high rates of compression and reconstruction. The loss mapping matrix computes the expected loss and achieve near to lossless reconstruction.

The various actions, acts, blocks, steps, or the like in the flow charts (S100 and S1700) may be performed in the order presented, in a different order or simultaneously. Further, in one or more embodiments, some of the actions, acts, blocks, steps, or the like may be omitted, added, modified, skipped, or the like without departing from the scope of the present disclosure.

The one or more embodiments disclosed herein can be implemented through at least one software program running on at least one hardware device and performing network management functions to control the network elements. The elements include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

What is claimed is:

1. A method for video compression in an extended reality (XR) environment by an electronic device, the method comprising:
separating at least one first feature from a multimedia stream;
separating at least one second feature from the multimedia stream;
applying a first compression to the at least one first feature to generate at least one compressed first feature;
applying a second compression to the at least one second feature to generate at least one compressed second feature;
generating a loss mapping matrix for the first compression, and the second compression;
generating a compressed multimedia stream comprising the at least one compressed first feature, the at least one compressed second feature, and the loss mapping matrix; and
transmitting the compressed multimedia stream to another electronic device.

2. The method as claimed in claim 1, further comprising storing the compressed multimedia stream in memory of the electronic device.

3. The method as claimed in claim 1, further comprising reconstructing the compressed multimedia stream.

4. The method as claimed in claim 3, wherein the reconstructing the compressed multimedia stream comprises:
reconstructing the at least one first feature from a compressed format using a generative data driven model to generate at least one reconstructed first feature;
reconstruct the at least one second feature from the compressed format using the generative data driven model to generate at least one reconstructed second feature; and
reconstructing the compressed multimedia stream by using the at least one reconstructed first feature and the at least one reconstructed second feature.

5. The method as claimed in claim 1, wherein the at least one first feature comprises at least one of: pixel information, depth information, spatial coefficient information, or edge information, and wherein the at least one second feature comprises at least one of: an amplitude, a frequency, or spatial audio information.

6. The method as claimed in claim 1, wherein the at least one first feature is a video feature, and
wherein the at least one second feature is an audio feature.

7. The method as claimed in claim 1, wherein, based on the at least one first feature corresponding to a video feature, the separating the at least one first feature from the multimedia stream comprises:
estimating a number of frames that an aggregator can accommodate based on at least one of: a width of the frames, or a length of the frames;
determining whether the frames are aggregated in a horizontal stacking or a vertical stacking based on an aspect ratio of the frames; and
separating the at least one first feature from the multimedia stream based on estimating the number of the frames and determining whether the frames are aggregated in the horizontal stacking or the vertical stacking based on the aspect ratio of the frames.

8. The method as claimed in claim 1, wherein the at least one second feature is separated from the multimedia stream prior to noise removal process associated with the at least one second feature.

9. The method as claimed in claim 1, wherein the multimedia stream is obtained by determining a time frame of the multimedia stream to be computed for frame aggregation and compression based on at least one of: computational power, speed, aspect ratio, or network performance.

10. The method as claimed in claim 1, wherein the loss mapping matrix is generated based on a pixel value between a lower pixel threshold and an upper pixel threshold, wherein the lower pixel threshold and the upper pixel threshold are varied based on an average intensity of pixels, wherein the lower pixel threshold and the upper pixel threshold are used to achieve near to lossless reconstruction of the compressed multimedia stream.

11. The method as claimed in claim 1, wherein the generating the loss mapping matrix comprises:
determining a difference between an original down-sampled aggregated frame and a reconstructed aggregated frame; and
determining a normal distribution of pixel loss and defining a range from which the electronic device 20 is to generate the loss mapping matrix.

12. The method as claimed in claim 11, wherein the range comprises at least one of: 0-63, 64-127, 128-191, or 192-255.

13. The method as claimed in claim 11, wherein, factoring in the normal distribution of the pixel loss, the loss mapping matrix is generated as: a row number in the loss mapping matrix; a column number in the loss mapping matrix; red, green and blue values; and a difference pixel value.

14. The method as claimed in claim 1, wherein the loss mapping matrix is provided with a feature metadata.

15. An electronic device comprising:
a communication interface;
at least one processor; and
memory storing one or more instructions,
wherein the one or more instructions, when executed by the at least one processor individually or collectively, cause the electronic device to:
separate at least one first feature from a multimedia stream;
separate at least one second feature from the multimedia stream;
apply a first compression to the at least one first feature to generate at least one compressed first feature;
apply a second compression to the at least one second feature to generate at least one compressed second feature;
generate a loss mapping matrix for the first compression and the second compression;
generate a compressed multimedia stream comprising the at least one compressed first feature, the at least one compressed second feature and the loss mapping matrix; and
transmit, by the communication interface, the compressed multimedia stream to another electronic device.

16. The electronic device of claim 15, wherein the one or more instructions, when executed by the at least one processor individually or collectively, further cause the electronic device to store the compressed multimedia stream in the memory.

17. The electronic device of claim 15, wherein the one or more instructions, when executed by the at least one processor individually or collectively, further cause the electronic device to reconstruct the compressed multimedia stream.

18. The electronic device of claim 15, wherein the one or more instructions, when executed by the at least one processor individually or collectively, further cause the electronic device to:
reconstruct the at least one first feature from a compressed format using a generative data driven model to generate at least one reconstructed first feature;
reconstruct the at least one second feature from the compressed format using the generative data driven model to generate at least one reconstructed second feature; and
reconstruct the compressed multimedia stream by using the at least one reconstructed first feature and the at least one reconstructed second feature.

19. The electronic device of claim 15, wherein the at least one first feature comprises at least one of: pixel information, depth information, spatial coefficient information, or edge information, and wherein the at least one second feature comprises at least one of: an amplitude, a frequency, or spatial audio information.

20. The electronic device of claim 15, wherein the at least one first feature is a video feature, and
wherein the at least one second feature is an audio feature.
